(19) United States
(12) Patent Application Publication
(10) Pub. No.: US 2004/0015455 A1
(43) Pub. Date: Jan. 22, 2004

(54) Postal or electronic mail addressing and processing method

(76) Inventor: Eliane Maarek, Boulogne Billancourt (FR)

Correspondence Address: YOUNG & THOMPSON, 745 SOUTH 23RD STREET 2ND FLOOR, ARLINGTON, VA, 22202

(21) Appl. No.: 10/312,716

(22) PCT Filed: Jun. 28, 2001
(86) PCT No.: PCT/FR01/02056

(30) Foreign Application Priority Data
Jun. 28, 2000 (FR) 00/08361

(51) Int. Cl. G06F 17/00

(52) U.S. Cl. 705/500

(57) ABSTRACT

The invention concerns a mail addressing and processing method which consists in using an identification number in Arab numerals, borne by the mail, to subject it to a database which identifies the addressee and his address. The identification number is the addressee's telephone number; the database is a database operating according to the principle of reverse directory; when the mail is being processed, it is superimposed with one or several value-added services are.

The present invention relates to a process, a device and material and software means for addressing and processing mail.

The present invention is applicable particularly to postal mail or electronic mail (currently called e-mail).

There is particularly encountered in these fields the risks of error connected to addressing; as well as considerable cost of sorting and sending the mail, particularly postal mail.

It has been proposed, to avoid errors of reading addresses, to replace the postal address by a lifetime identification number for each physical person or a legal entity. Such a lifetime identification number would be indicated on the envelope of the postal mail and read by an optical reader so as to determine, by interrogating a database, the name and address of the person to whom this number has been attributed.

The principal drawback of this project is the attribution of a specific number to each person for his lifetime, which requires, on the one hand, an enormous work of recording an entire population; and, on the other hand, for senders of mail, learning and memorizing this identification number, for each person or company to whom he wishes to write.

The document GB 2 225 999 relates to a process for postal sorting comprising the application of an element adapted to be sent, a coded message indicating the address of the destination. The message is coded so as to be able to be read by a machine and the posted element is transmitted to one or several places for sorting having machines adapted to read the coded message. The machines are adapted to sort the posted element as a function of the address indicated by the coded message. Typically, the coded message is representative of a telephone number of the addressee and there is also a second coded message which is representative of the address or the identity of a sender.

The coded message is representative of a telephone number of the addressee; because, at this time, structure of the telephone number of the addressee would indicate his geographic position. The structure of the telephone number of the addressee indicating his geographical position thus permits sorting the mail by successive steps, until the final destination, corresponding to the geographic location of the telephone exchange.

At present, more than half the telephone numbers are numbers called in the telecommunication profession “virtual numbers” or “non-geographic numbers”, more commonly mobile phone numbers or “free” or “semi-free” numbers (green, blue numbers). These “virtual numbers” or “non-geographical numbers” do not correspond with a geographic location, which frustrates the use of a postal sorting procedure according to GB 2 225 999.

At present, fewer than half the telephone numbers are numbers called in the telecommunication profession “fixed numbers”, of the type TZ APBQ MCDU.

These “fixed numbers” begin effectively with a “TZ”, wherein Z is the so-called “zone” number, but this zone, defined by the historical operator of telecommunications, does not correspond to the zones of postal sorting. The numerals following the “fixed numbers”, called “ABPQ”, also called “indicators”, have a connection with “quarters” or “neighborhoods”, but are now assigned according to criteria that no longer correspond with the geographic location.

Moreover, at present, it is required by a European Commission directive to make “portable” all the telephone numbers, to prevent for example a person residing in a region of Paris to keep his number after he moves to the countryside. The connection between the telephone number and the geographic location can accordingly no longer be used in the European Union, which frustrates use of a postal sorting system according to GB 2 225 999.

U.S. Pat. No. 6,052,445 relates to a system and process for routing telecopies by the most economical route, by using the Internet address of the addressee when the latter figures in a table of correspondence of Internet addresses and of telecopy numbers and by composing directly the telecopy number of the addressee when the Internet address of the addressee is not in this table of correspondence of Internet addresses and telephone numbers.

The principal drawback of this system and of its processes for routing telecopies by the most economical route, is to require considerable work in constructing this table of correspondence of Internet addresses and telecopy numbers of all the addressees and to make indispensable the purchase of a telecopy routing system by the most economical way, comprising a device for switching telecopies containing this table of correspondence of Internet addresses and telecopy numbers and a processor configured to carry out one of these routing processes of telecopies by the most economical way.

An object of the present invention is to provide a new process, more simple and economical than the postal sorting system according to GB 2 225 999, and than the routing processes for telecopies according to U.S. Pat. No. 6,052,445.

Another object of the invention consists in simplifying the approach of the postal or electronic mail emitters, thanks to the use of Arabic numerals of the telephone number or telecopy, fixed or mobile, of the addressee as a means for indicating the postal address or the electronic mail (now called e-mail).

In the present description and in the claims, there will be indicated by the expression “telephone number” a telephone number or telecopy number, fixed or mobile, or non-geographic.

Another object of the invention is the use of databases already existing in directories operating according to the reverse directory principle to identify the name and address of the addressee.

The present invention departs from the principle that telephone numbers, fixed or mobile, are now extremely widespread and that their memorization, personal or professional, is generally in Arabic numerals, differently from postal addresses.

The telephone numbers in Arabic numerals constitute a system of information generating fewer errors of reading and interpretation than the addresses in letters. The use of Arabic numerals finally permits rendering a considerable service to senders of mail, and equally significantly decreases the cost of errors.

The process according to the invention comprises principally the steps of using as identification means of the addressee a telephone number in Arabic numerals, reading this telephone number in Arabic numerals, interrogating the existing databases of directories operating according to the reverse directory principle to identify the name and address of the addressee, applying to the mail its address for deliverance to the addressee, for example the postal or electronic address, and if desired the name of the addressee.

The process according to the invention is more simple and economical than known processes; because its practice is immediate, there are used existing means such as reverse directors to solve the problems of addressing, and there is superposed on the usual simple service of directing mail, a multitude of “value added” services.

Thanks to the process according to the invention, the relations are simplified between the general public and the companies or among companies, by modernizing and rendering dynamic the mail with the following advantages:

the memorization by users of telephone numbers is easy;

the content of personal directories is facilitated because there is inscribed therein only the telephone numbers and less and less often the addresses;

it is possible, for a same person, to write any one of his telephone numbers, fixed or mobile

one can, for a company, writ one or the other of its telephone numbers (fax, green number, indigo number or others) without having need to know its address.

In the particular case of electronic mail, it often happens that one does not know exactly the “e-mail” of his correspondent, because the addresses of electronic mail are difficult to memorize and the change in position of even a period or symbol renders inoperative such an address; on the contrary, there is generally known the telephone number whose memorization is easy; the process according to the invention will thus equally facilitate the use of electronic mail by modernizing and rendering dynamic the electronic mail by the advantages mentioned above.

The practice of this process requires that the mail pass through a specific processing center, if desired located in a sorting center and/or routing center, to carry out at least the following operations:

affixing the postal address of the owner of the telephone number in Arabic numbers;

adding the electronic address (now called e-mail) of the owner of the telephone number in Arabic numerals.

The process according to the invention can further comprise, in contrast to the present mode of processing mail, whether postal or electronic, which comprises no supplemental service, the use of one or several “value added services”, as a function of the sender and/or of the addressee, according to the following non-limiting list:

affixing the name of the owner of the telephone number with the corresponding postal address to the envelope and special handling in the case of postal mail;

adding the name of the owner of the telephone number with the electronic address (now called e-mail), and electronic dispatch of the mail in the case of electronic mail;

preventing sending according to instructions of the addressee (for example preventing the sending of advertising mail, or preventing mail emitted by a sender or a specific list of senders);

selection of the senders (as a function for example of their telephone number or their electronic address), in particular senders of information or advertising;

transfer of the temporary or final postal or electronic address (for example by a person on vacation or who has moved or in the hospital, or else for a company in formation) for the postal mail: toward another postal address; and for electronic mail: toward another e-mail address;

return to the sender under conditions

copy of the electronic mail toward one or several other e-mail addresses;

sending an alert message (for example by SMS) to the addressee of the mail;

masking the telephone number for users who do not want their telephone number to be displayed beside their address (red list subscribers for example) in the case of postal mail;

sending to a particular person designated by the sender within a company, a family, an association . . . ;

introduction of the postal mail into a packet bearing the name and address as well as perhaps the addition of message, for example advertising, with the envelope in the packet;

adding an electronic document in the case of electronic mail;

charging to the addressee the cost of sending postal mail (for example the equivalent of postage), in a manner analogous to collect calling by telephone, the collect expression meaning that the price is paid by the addressee;

charging the sender and billing the difference of the charges of sending by postal mail;

acknowledgement of receipt of the postal or electronic mail;

or any other service in combination with supplemental services, as a function particularly of the characteristics of subscription or of the equipment of the sender and/or of the addressee;

as well as possible affixation of a code permitting, for postal mail, automatic sorting, this code being possibly for example a barcode.

The invention has for its object a process for addressing and processing mail, particularly postal or electronic mail, comprising the following steps:

addressing the mail by using as an indication of the destination a telephone number, in Arabic numerals, present in at least one existing database, functioning according to the principle of reverse directory to identify the name and address of the addressee from said telephone number;

searching at least the address for delivering the mail to the addressee corresponding to said telephone number in said existing database, operating according to the principle of the reverse directory to identify the name and address of the addressee from said telephone number;

applying to the mail his address for delivery to the addressee, for example the postal or electronic address, and if desired the name of the addressee.

directing the mail as a function of said delivery address to the addressee;

and causing the mail to arrive at said address for delivery to the addressee.

The invention also has for its object an envelope to use a process for addressing and processing postal mail according to the invention.

For the postal mail, in a process for addressing and processing postal mail according to the invention, the sender can use a usual new envelope and only inscribe thereon the telephone number of the addressee. A system of automatic centering on the numbers, forming a part of the optical reading module, makes possible a correct optical reading. However, to facilitate the reading of this telephone number, it is preferable to provide an envelope with a dedicated zone comprising separate boxes in which the sender will write the numbers comprising said telephone number. According to another modified process, there can be used an envelope comprising, beside the dedicated zone comprising the boxes adapted to receive the digits of said telephone number, another dedicated zone adapted to receive the name and address of the addressee; this address can be either printed directly on the envelope in this second zone, or printed on a ticket (self-sticking or not) which will be affixed to the envelope. Preferably, the sender of the mail can use special envelopes comprising boxes adapted for the inscription of the telephone number.

The digits constituting the telephone number of the addressee are written by the sender, box by box, and the mail is then processed automatically to ensure the printing of the postal coordinates of the addressee, and if desired the identification of the addressee and/or the printing of additional codes for automization of sorting and/or for a particular processing.

For postal mail, a process of addressing and processing the postal mail comprises preferably the following processing steps:

a) reading from the mail a telephone number in Arabic numerals, which indicates the addressee;

b) transmitting said telephone number read in step a) to interrogate a database operating as a “reverse directory”;

c) interrogating the database operating as an “reverse directory”, so as to receive a response signal comprising at least the address of the destination corresponding to said telephone number, and if desired the name of the addressee;

d) adding or associating at least the address of the destination to said mail, so as to permit sending said mail in a reliable and economic manner.

In addition to the address for delivering to the addressee, the machine can affix to an envelope or a packet containing the envelope:

a code permitting automated sorting;

one or several additional codes or signs corresponding to one or several “value added” services, carried out during processing the mail.

The invention also has for its object a device for processing mail, particularly postal or electronic mail, addressed by using as an indication of the addressee a telephone number in Arabic numerals present in at least one existing database, comprising in combination:

means to search at least the address for delivery of the mail to the addressee corresponding to said telephone number in said existing database, operating according to the principle of a reverse directory to identify the name and address of the addressee from said telephone number in Arabic numerals;

means to apply to the mail the address for delivery to the addressee, for example the postal or electronic address, and if desired the name of the addressee.

means to direct the mail as a function of said address for delivery to the addressee.

a module comprising a processing program;

a reading module;

a database;

and a writing module;

such that, when an envelope passes into the reading module, the processing program commands successively the reading of the number in Arabic numerals carried by the envelope, the interrogation of the database to obtain the effective address corresponding to the number read in Arabic numerals, and the writing of said address by the writing module.

The device for practicing a process according to the invention, for postal mail, conventionally comprises: a database used according to the principle of the reverse directory; a machine which effects reading of the digits comprising the telephone number, then interrogates the database and prints the name and postal coordinates corresponding to the telephone number and possibly adds a code, a barcode for example which will permit automatic sorting; and envelopes comprising digits of the telephone number of the addressee.

Preferably, the device for postal mail can comprise, before the reading module, an input module for envelopes; and after the writing module, a module for automatic distribution of the envelopes in bins, the input modules for reading, writing and distribution being traversed successively by the envelopes.

Preferably, a device for postal mail moreover comprises: between the reading module and the processing module, a module comprising a recordation program for the envelopes, and/or a module comprising a file of processed envelopes; and between the reading module and the writing module, a module for printing a code, a barcode for example; such that the reading of the telephone number by the reading module:

triggers the recordation of the envelope by the module comprising the recordation program for the envelopes which allots to it an order number;

control of the printing on the envelope of a barcode corresponding to said order number, by the printing module;

control of the memorization, in the file of processed envelopes, of the telephone number and the order number.

Preferably, the processing module of a device for postal mail:

interrogates the file of the processed envelopes to extract from it the telephone number and order number;

interrogates the database to obtain the effective address corresponding to the telephone number.

Preferably, the processing module controls the writing of the address by the writing module after verification of conformity between the order number and the code carried by the envelope and if desired controls the printing of another code corresponding to a particular service.

The use of this process can require, for the organism for processing the mail, that the different organisms managing the telephone subscriptions communicate the necessary data to the mail processing center.

The case of subscribers to the red list requires a particular treatment because it is necessary to avoid the simultaneous appearance on the envelope of the telephone number, and the name and address of the addressee.

To this end, the data transmitted by the mail processing organism should comprise a code which permits recognizing that the subscriber, whose number is read, is on the red list (unlisted). One can then: either imprint, in addition to the name and postal coordinates of the addressee, the signs which mask the digits of the telephone number; or print a label which will cover the boxes of the telephone number; or print a packet into which is introduced the mail to be processed.

The use of such a packet is interesting to permit adding to the mail advertising or a mailing. In the case of a mailing, there could be used, either an envelope containing personalized mail, or a simple card carrying the telephone number and this card would be introduced into the packet with the mailing.

The invention will be better understood from the description which follows, given by way of non-limiting example, with reference to the accompanying drawings, in which:

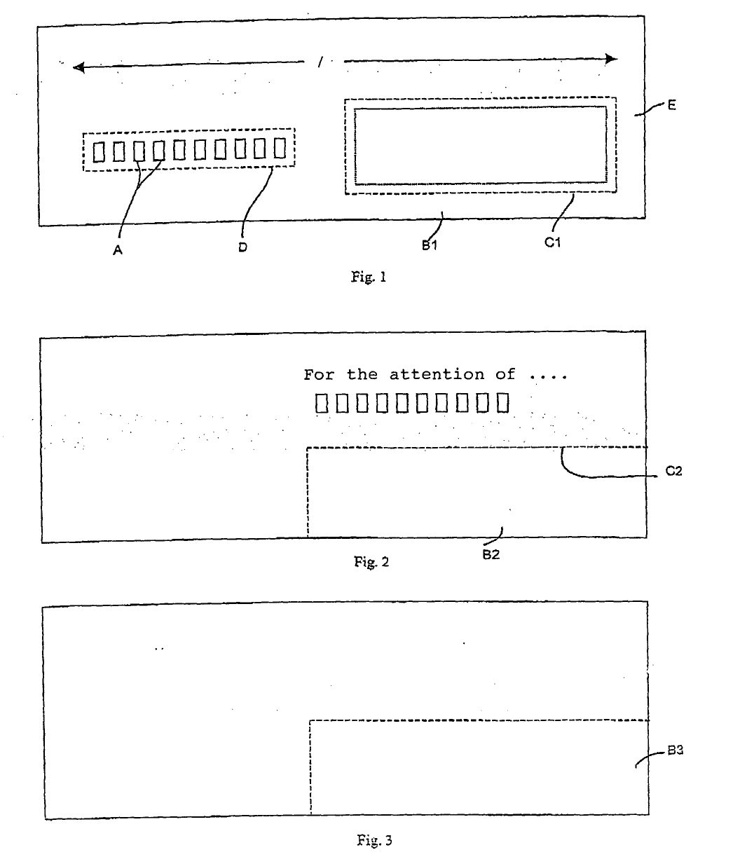

FIG. 1 shows schematically a view of an embodiment of a specific envelope permitting the use of the process according to the invention.

FIG. 2 shows schematically a view of another embodiment of an envelope permitting the practice of the process according to the invention.

FIG. 3 shows schematically a view of a packet adapted to receive the envelope, according to a modified embodiment of the invention.

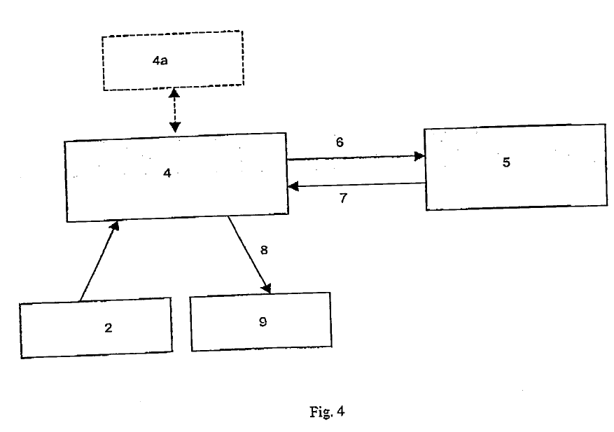

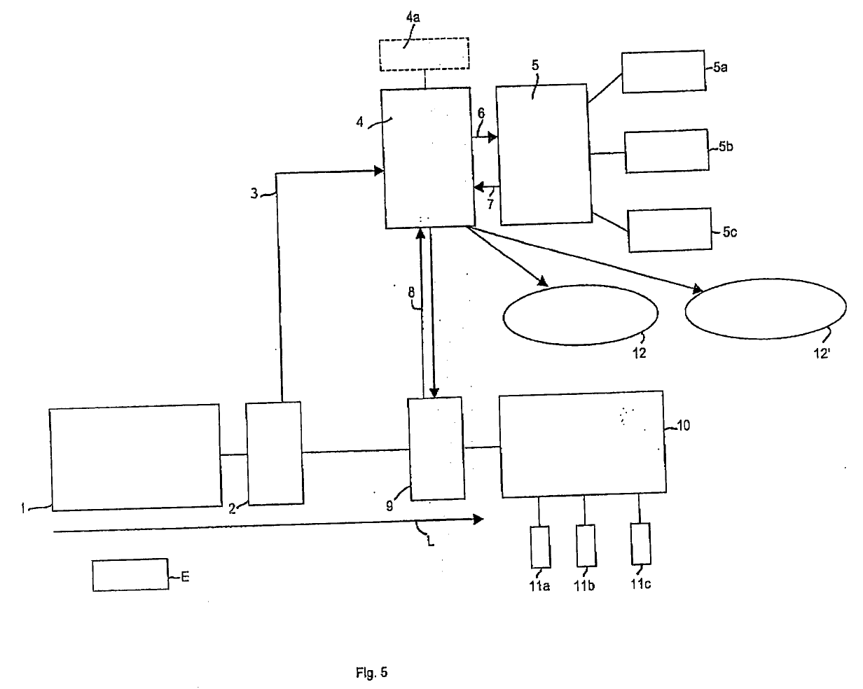

FIG. 4 shows schematically an organogram illustrating a simplified practice of the process according to the invention.

FIG. 5 shows schematically an organogram illustrating a second manner of practicing the process according to the invention.

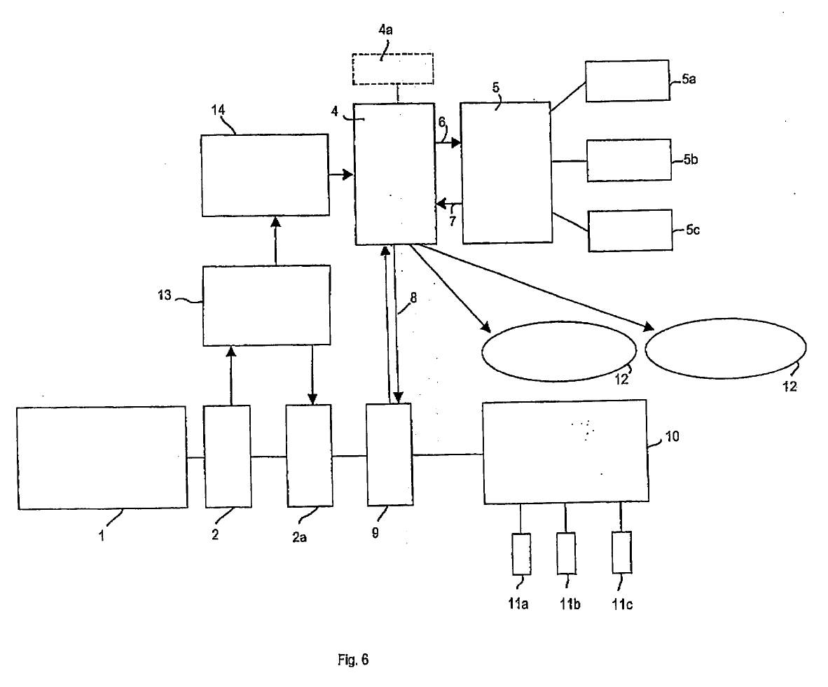

FIG. 6 shows schematically an organogram illustrating a third more complete manner of practicing the process according to the invention.

In FIG. 1, a specific envelope permitting the use of a process according to the invention (national mail) comprises two zones A and B₁.

Zone A comprises 10 boxes (national mail) in which the sender of the mail will write, box by box, the digits comprising the telephone number of the addressee of the mail.

Zone B₁ is free and, preferably, as shown, but not necessarily, delimited by a rectangular box C₁, within which can preferably be disposed an instruction not to write in this box.

According to a modification (not shown), for international mail, a specific envelope can comprise two zones A₁ and B₁, zone A₁ comprising more boxes than before (the international telephone number being longer than a national number because it includes a country code) so that the sender of the mail can write, box by box, the digits comprising the international telephone number of the addressee of the mail.

A printable box D surrounds a zone A or a zone A₁. This printable box D delimits a rectangular surface adapted for the printing of a rectangular black bar to prevent the reading of the telephone number of the addressee written by the sender in the case of an addressee with an unlisted number, which is to say a subscriber on the list of telephone numbers that must remain confidential.

In FIG. 2, the envelope illustrated comprises a zone B₂ in the lower right portion, above which the telephone number can be written, in preprinted boxes or in the absence of boxes, at any place on the external surface of the box C₂ of FIG. 2.

A supplemental indication of the particular addressee is possible after the wording: “for the attention of”, in the case in which the telephone number is that of an enterprise or an organization including several persons, or even a family.

In FIG. 3 is shown an example of a packet in which will be disposed the mail or the envelope after reading of a telephone number or an order number.

The front of the packet, alone visible in the figure, is opaque, which prevents reading what is inscribed on the front of the envelope inserted in the packet, and permits masking the telephone number written on this envelope.

The back of the packet can be transparent, to permit reading the possible indication of the sender carried on the back of the envelope inserted in the packet.

The zone B₃ is adapted to receive the application of the address.

This packet containing the mail or the envelope moreover permits adding to the mail additional elements such as advertising, circulars, mailings or the like.

FIG. 4 is an organogram which shows a simplified practice of the invention.

In this FIG. 4, an installation for using the invention comprises an optical reading device 2, which reads the telephone number written on the envelope and sends, by route 3, a signal corresponding to the telephone number read toward the processing module 4.

The processing module 4 contains a processing program, interrogates line 6 one of the databases 5 operating as a reverse directory, and receives by line 7 a responding signal representative of the address, and if desired the name, corresponding to the telephone number.

The processing module 4 then interrogates if desired an optional module 4a to learn whether the sender and/or the addressee have a special service such as for example the refusal by the addressee to receive advertising.

As a function of the instructions received from modules 5 and 4a, the processing module 4 transmits, by line 8, signals permitting the writing module 9 to print the name and address on the envelope, and if desired to print special indications.

This simplified arrangement for practicing the invention, shown in FIG. 4, permits manual processing of the mail. It can preferably be used either to carry out a pilot installation for the process, or in geographic regions where the quantity of mail to be processed is insufficient to justify economically automatic installations described above, in relation to FIGS. 5 and 6.

Thus, to save the optical reader 2, an operator can read the telephone number and type it on a computer keyboard connected by line 3 to the module 4. The module 2 can thus be either an optical reading module or a station for visual reading and manual acquisition on the keyboard, without departing from the scope of the present invention.

The module 4 writes the address, including if desired a name, on the envelope or on a packet in which is inserted (manually or automatically) the envelope; or emits a label bearing the address, which is then affixed (manually or automatically) to the envelope or a packet in which is inserted the envelope.

With reference to FIG. 5, identical or functionally equivalent elements to those of FIG. 4 have the same reference numerals as in FIG. 4.

In FIG. 5, a more complicated installation for practicing the invention comprises a module 1 for receiving envelopes to present the envelopes to the module 2.

As described with reference to FIG. 4, the module 2 or optical reader 2 reads the telephone number, and transmits it to the processing module 4, which interrogates by line 6 the database 5 and if desired the module 4a.

As shown in FIG. 5, the database 5 is connected to or constituted by databases 5a, 5b, 5c or the like, of various telephone operators and is used according to the principal of the reverse directory.

It can happen that the telephone number will be unknown to these databases 5a, 5b, 5c or the like, or will be poorly written in boxes A: in this case, the processing module 4 sends a signal to the module for error processing, which controls the discharge of the envelope which is then manually processed.

Moreover, if the module 4a sends to the module 4a signal, for example preventing advertising (for subscribers on the orange list), the module 4 sends a signal which triggers a particular processing of this mail by a module 12a.

In the installation of FIG. 5, the envelopes at the end of the path are sorted and automatically grouped into bins such as 11a, 11b, 11c corresponding to specific routes.

In the installation of FIG. 5, the envelopes E are sent from station to station by a conveyor L.

To avoid having complete correspondence between the path of the envelopes E and the path of the signals toward the printing module 9 such that what is printed on an envelope may not correspond to the proper envelope, means or arrangements are provided to ensure this correspondence.

For sorting centers of low importance, it is necessary to introduce a new envelope E only when the previous one has fallen into one of the bins 11.

For large sorting centers, there is applied to the envelope, at the time of its reading, a distinctive sign which then ensures its good printing.

With reference to FIG. 6, identical or functionally equivalent elements to those of FIG. 5 have the same reference numerals as in FIG. 5.

In FIG. 6, between the optical reading module 2 and the processing module 4, are interposed two modules 13 and 14.

The module 13 comprises a program which records the telephone number which has been optically read and associates with it an order number or a distinctive sign by any suitable means: for example by means of a barcode, which is immediately imprinted on the envelope by the module 13. Preferably, the order number includes the number of the processing center, the date and time, a lot number, and a number in the lot.

Thus the envelope bears a distinctive sign, which permits desynchronized processing by lots, as well as ultimate error processing.

The module 13, associating an order number with each telephone number corresponding to an envelope carrying its order number or distinctive printed sign, sends these two numbers to the module 14.

The module 14 contains a file of the envelopes processed and memorizes these two numbers in a file which can serve for eventual reclimation.

The module 4 interrogates the file of the processed envelopes, then interrogates, number by number, as in the preceding case, the database 5 and if desired the module 4a.

The response signal is transmitted to the module 4 which commands the writing of the address by the printing module 9.

In the module 9, printing is triggered only after reading the order number or distinctive sign previously applied to the envelope and verification that this order number or distinctive sign corresponds to the order number connected to the printing signal.

These operations, although described as connected to each other in a sequential order, can be disassociated time-wise.

One can also, in a first instance, store in a memory all the data from the databases 5 and from the module 4a and trigger the printing only afterward.

All the operations can be separated time-wise, by having as many memories as necessary: this permits a very flexible practice of the process according to the invention.

To permit automatic sorting, the processing module 4 sends to the printing module 9 a signal causing the printing at the same time as the address and/or the name of the addressee, of another code, for example in the form of a barcode, which will permit a device 10 to proceed to automatic sorting of the courier thus provided with information.

In the case of an unlisted subscriber, which is to say on the list of telephone numbers to be kept confidential, it is necessary to prevent the reading of the telephone number inscribed by the sender. If the printing of the address and/or of the name is done directly in box C₁ on the envelope, there can be provided the printing of a rectangular black bar in the box D which surrounds a zone A. If the printing takes place on a label applied to the envelope, it is given dimensions sufficient to cover the zones A and B₁.

Another way of proceeding to prevent the reading of the telephone number written by the sender, consists in introducing the envelope E into an additional packet, which carries only the address and the name of the addressee. The insertion of the envelope in the packet takes place preferably before the envelope reaches the printing module 9. In the case in which the envelope comprises zones on which the sender can identify, for example on the back of the envelope, the sender can identify himself, for example on the back of the envelope, the additional packet comprises a transparent back so as not to mask this writing.

Without actually being unlisted, certain users do not want their telephone number applied to the envelopes of mail sent to them. In this case, upon request, there can be introduced into the database 4a a code which causes the envelope to be processed as though the subscriber were unlisted.

The processing in a packet can take place upon request of the senders, upon request of the addressees or else by decision of the postal operator; the latter can decide to process all the mail in this manner.

It is possible to insert in the same packet a document, for example an information document, an advertising document, a circular, a mailing . . . .

The introduction into the packet of additional documents can be accompanied by a weighing operation so as not to exceed the maximum weight corresponding to the cost of the postage initially provided. This permits carrying out advertising mailing without supplemental cost.

In the case of processing a mailing, the sender can give to the processing service the number of desired copies of his mailing as well as a list of telephone numbers and there is placed a copy of the mailing in a packet, to which the names and addresses of the addressees are printed from the listing.

With the permission of the postal operator, the sender, a company for example, can use envelopes provided, by preprinting if desired, with a code permitting identifying it. The mail, sent without postage in such envelopes, is thus weighed and charged an amount corresponding to the handling of its mail.

Such an arrangement considerably simplifies the mail service for companies and requires simply a supplemental code reading module (generally the telephone number of the sender completed by a confidential code) and recordation in a file permitting billing. Preferably, this code attributed to each client of the postal operator changes daily, so as to avoid the risk of fraud.

This billing can be paid in advance by a “credit card” representing “postage”: in this case, the postal operator sells a number of “ranking units”, or their value in money, to a client identified by his telephone number. On the occasion of each mailing, the operations of weighing and looking up the tariff in a database as a function of the sender/addressee couple—or sending/placing office of the addressee—permits counting down the remaining amount of money.

Similarly, the postal operator can, as a function of the weight and of the sender/addressee pair—or sending/placing office of the addressee—increase an amount which will then be billed to the sender or to the addressee as the case may be.

It is also possible, according to the present invention, to establish a service analogous to the PCV telephone service. An addressee can make it known that he accepts, if desired for a given period, receiving unstamped mail, the cost of sending being billed to him. This indication introduced into the module 4a ensures that the mail accepted without postage is weighed and billed by the amount corresponding to the processing of this unstamped mail, by use of a particular file for the cost of mail for its billing to the addressee.

There can be used the process according to the invention when several persons have a same telephone number (family, company, association . . . ).

In any case, the sender can identify himself also by his telephone number; this permits the sender to post a letter without postage, the processing device can then weigh the letter and bill the sender.

In all the examples described above, there has been taken as the identification key of the addressee his telephone number; but according to the present invention, there can also be used his telefax number (which is a telephone number); or the electronic address of the addressee.

In the case in which a person has no telephone and no telefax nor an electronic address, it is possible to give him a “virtual” telephone number which is introduced into the database 5 in the place of a “real” telephone number.

The present invention is also applicable to electronic mail (now called e-mail).

In the case of electronic mail, there are used material or software means analogous to those described with reference to FIGS. 4 to 6.

There is employed as the identification element the telephone number.

An electronic reading module 2 reads this number; transmits it in digital form to the processing module 4; which interrogates a database containing the e-mail addresses used according to the reverse directory principle. The database 5 then transmits the e-mail address to the electronic writing module 9 which recomposes the electronic message with the transmitted e-mail address.

In this case, material or software means analogous to the installation of FIG. 4 can be used.

An additional module 4a can be used to give supplemental instructions, such as for example a transfer of e-mail address or copying it to another e-mail address.

Similarly, in the case of postal or electronic mail, the shipment passes to the sorting and/or routing means, receives supplemental processing or is directed toward a specific processing center.

This process permits the mail (postal or electronic) to benefit from supplemental services, similar to those of various telephone operators offering to their clients services commonly called “value added services”.

In all of the above, the first operation is constituted by the reading of the telephone number, this operation permitting then adding additional services, “value added services”, at the choice of the sender and/or the receiver.

The sender can also write the address of the addressee and write his own telephone number and his confidential code on the front of the envelope, to benefit from the weighing and billing service, which is interesting to lessen the service charges for mail in a company, and, in particular cases, to avoid the constraints connected with stamping. The company can benefit from a code which is peculiar to it for automatic billing.

Each of the added value services described above can be associated with the mail independently of other services.

1. Process for addressing and processing mail, particularly postal or electronic mail, comprising the following steps:
addressing the mail, particularly postal or electronic, by using as an indication of the addressee a number, in Arabic numerals, of a telephone or telecopy, fixed, mobile or non-geographic, hereinafter called a “telephone number”,
searching for at least the address for delivery of the mail, particularly postal or electronic, to the addressee corresponding to said telephone number in at least one existing database, operated according to the principle of a reverse directory, to identify the name and address of the addressee from said telephone number;
applying to the mail, particularly postal or electronic, the address for delivery to the addressee, for example the postal or electronic address, and if desired the name of the addressee,
directing the mail, particularly postal or electronic, as a function of said address for delivery to the addressee;
and causing the mail, particularly postal or electronic, to reach said address for delivery to the addressee.

2. Process according to claim 1, for addressing and processing postal mail, comprising the following processing steps:
reading on the mail a telephone number in Arabic numerals, which indicates the addressee;
transmitting said indicative numeral read in step a) to interrogate a database (5) operating as a “reverse directory”;
interrogating the database (5) operating as a “reverse directory”, so as to receive a response signal comprising at least the address of the destination corresponding to said indicative number, and if desired the name of the addressee;
adding or associating at least the address of the destination to said mail, so as to permit directing said mail in a reliable and economical manner.

3. Process according to claim 1 for addressing and processing mail, particularly postal or electronic mail, characterized by the fact that, during processing of the mail for its dispatch, there is added, as a function of the request of the sender, and/or of that of the addressee, at least one specific processing, called “added value”, selected for example from the non-limiting following list:
affixation of the name of the owner of the telephone number with the corresponding postal address on the envelope, in the case of postal mail;
adding the name of the owner of the telephone number with the electronic address (now called e-mail), in the case of electronic mail;
preventing the dispatch according to instructions of the addressee (for example preventing dispatch of advertising mail, or preventing mail by a sender or a list of specific senders);
selection of the senders (as a function for example of their telephone number or of their e-mail address), in particular of senders of information or advertising;
transfer of a temporary or final postal or e-mail address (for example for a person on vacation or moving or hospitalized, or else for a company in formation)—of the postal mail to another postal address, and for electronic mail toward another e-mail address;
return to the sender under conditions
copying electronic mail to one or several other email addresses;
sending an alert message (for example by SMS) to the addressee of the mail;
masking the telephone number for users who do not want their telephone number to be placed beside their address (unlisted subscribers for example) in the case of postal mail;
sending to a particular person designated by the sender within a company, a family, an association . . .
introduction of the postal mail into a packet carrying the name and address as well as if desired the addition of a message, for example advertising, with the envelope in the packet;
adding an electronic document in the case of electronic mail;
charging the addressee with the cost of sending postal mail (for example the equivalent of postage) in a manner analogous to collect telephone calls, the expression collect meaning that the price is paid by the addressee;
charging the sender and billing “delayed” the cost of sending postal mail;
acknowledgement of receipt of the postal or electronic mail.

4. Process according to claim 1 or 2 for processing postal mail, characterized by the fact that it comprises the steps consisting in:
using as an identification of the addressee a telephone number;
associating by means of a processing module (4) a database (5) and the identification of the addressee, so as to obtain an effective address including if desired a name;
printing on the envelope (E) the data from the database (5).

5. Process according to claim 1 or 2 for handling postal mail, characterized by the fact that it comprises the steps consisting in masking the telephone number written on the postal envelope: for example by printing a black bar over the number or by application of a label at the place of the number, so as to cover it, or by insertion of the envelope in a packet on which are affixed the coordinates of the addressee.

6. Envelope for practicing a process for addressing and processing postal mail according to one of claims 1 to 5, comprising a surface on which the sender can affix the telephone number in Arabic numerals which indicates the addressee, comprising preferably a zone (A) provided with boxes permitting inscribing the numerals constituting the telephone number.

7. Envelope according to claim 6, characterized by the fact that the envelope comprises a zone (B) adapted to receive the address and if desired the name of the addressee.

8. Envelope according to claim 6 or 7, characterized in that the name and address are printed directly on the envelope or on a label (for example self-sticking) affixed to the envelope or to a packet containing the envelope.

9. Process according to claim 1 or 3 for addressing and processing electronic mail, characterized by the fact that it comprises the following steps:
using as an identification of the addressee a telephone number;
associating, by means of a processing module (4), this telephone number and a database comprising e-mail addresses so as to obtain the e-mail address corresponding to this telephone number;
substituting on the electronic mail, the e-mail address (including if desired the name) for the telephone number, or simply adding the e-mail address to the electronic mail;
transmitting the document with the discovered e-mail address.

10. Device for processing mail, particularly postal or electronic mail, addressed by using as an indication of the addressee a telephone number in Arabic numerals found in at least one existing database, comprising in combination:
means to search at least the address for delivery of the mail particularly postal or electronic, to the addressee corresponding to said number in said existing database, functioning according to the principle of the reverse directory to identify the name and address of the addressee from said telephone number in Arabic numerals,
means to apply to the mail particularly postal or electronic, his address for delivery to the addressee, for example the postal or electronic address, and if desired the name of the addressee,
means to direct the mail particularly postal or electronic, as a function of said address for delivery to the addressee.

11. Device according to claim 10 for the processing of postal mail, comprising in combination:
means (2) to read on the mail an identification number of the addressee
means (4) to transmit said read identification number so as to interrogate a database (5) functioning as a “reverse directory”; and to interrogate the database (5) functioning as a “reverse directory”, so as to receive a response signal comprising at least the address of the addressee corresponding to said identification number, and if desired the name of the addressee;
means (9) to add or associate at least the address of the destination to said mail, so as to permit sending said mail in an economical manner with minimum errors,
in which said identification number is the telephone number of the addressee and in which the address of the destination is the effective address of the mail of the addressee; such that, when an envelope passes through the reading module (2), a processing program controls successively the reading of the telephone number borne by the envelope, the interrogation of the database (5) to obtain the effective address corresponding to the telephone number read, and the writing of said address by the writing module (9).

12. Device according to claim 11 for the processing of postal mail, comprising one or several of the following additional means:
a—means to classify and introduce envelopes (E) into an optical reader (2);
b—means to transport the envelopes (E) from one module to the other;
c—means to print, at the same time as printing the address, a code permitting automatic sorting;
d—means to apply a label comprising the address of the addressee on the envelope;

13. Device according to claim 11 or 12 for the processing of postal mail, comprising one or several of the following additional means;
means to identify one by one the envelopes at the time at which they are read by the optical reader (2);
means to give them one by one an order number and to record it in a memory;
means to print the order number on the envelope;
means to print on the envelope a black bar permitting preventing reading of the telephone number;
means to associate this order number to that of the identification;
means to permit the printing of the postal address only, if there is agreement between the identification and the order number of the envelope;
means permitting printing on a packet or applying a label on a packet;
and means to insert the envelope in the packet.

14. Device according to claim 11 for the processing of postal mail, comprising: before the reading module (2), an input module (1) for envelopes; and after the writing module (9), a module (10) for automatic distribution of the envelopes into bins (11), the input module (1), the reading module (2), the writing module (9) and the distribution module (10) being traversed successively by the envelopes.

15. Device according to claim 11 for the processing of postal mail, characterized in that the database (5) is connected to or constituted by databases (5a, 5b, 5c) from different telephone operators.

16. Device according to any one of claims 11 to 15 for the processing of postal mail, comprising:
between the reading module (2) and the processing module (4), a module (13) comprising a program for recording envelopes, and a module (14) comprising a file of processed envelopes;
and between the reading module (2) and the writing module (9), a module (2a) for printing a code such as a barcode; such that:
the reading of the telephone number by the reading module (2) triggers the recordation of the envelope by the module (13) comprising a program for recording envelopes which gives it an order number; controls the printing on the envelope of a code such as a barcode corresponding to said order number, by the printing module (2a); controls the memorization, in the file (14) of processed envelopes, of the telephone number and of the order number.

17. Device according to claim 16 for the processing of postal mail, characterized in that the processing module:
interrogates the file (14) of processed envelopes to extract from it the telephone number and the order number;
interrogates the database (5) to obtain the effective address corresponding to the telephone number read.

18. Device according to claim 16 for the processing of postal mail, characterized in that the processing module (4) controls the writing of the address by the writing module (9) after verification of conformity between the order number borne by the envelope and said address.

19. Device according to any one of claims 11 to 15 for the processing of postal mail, comprising means to mask the telephone number written on the postal envelope: for example by printing a black bar over the number or by application of a label on the place of the number, so as to cover it, or by insertion of the envelope into a packet on which are affixed the coordinates of the addressee.

20. Device for practicing a process according to claim 1 for processing of electronic mail, comprising in combination:
means (2) to read on the mail an identification number of the addressee
means (4) to transmit said identification number read so as to interrogate a database (5) operating as a “reverse directory” and to interrogate the database (5) operating as a “reverse directory”, so as to receive a response signal comprising at least the address of the destination corresponding to said identification number, and if desired the name of the addressee;
optional means (4a) for supplemental services,
means (9) to add or associate at least the address of the destination of said mail, so as to permit sending said electronic mail in an economical manner with minimum error,
in which said identification number is the telephone number of the addressee and in which the address of the destination is the effective address of the electronic mail of the addressee; such that, when electronic mail passes through the reading module (2), a processing program controls successively the reading of the telephone number carried by the electronic mail, the interrogation of the database (5) to obtain the effective address corresponding to the telephone number read, and the writing of said address by the writing module (9).
